(19) United States
(12) Patent Application Publication
(10) Pub. No.: US 2023/0390773 A1
(43) Pub. Date: Dec. 7, 2023

(54) APPARATUS, SYSTEM, AND METHOD FOR ANALYTE RELEASE

(71) Applicant: Clara Biotech, Inc., Lawrence, KS (US)

(72) Inventors: Navdeep Singh, Lawrence, KS (US); James West, Lawrence, KS (US); Mei He, Gainesville, FL (US)

(21) Appl. No.: 18/247,958

(22) PCT Filed: Oct. 5, 2021
(86) PCT No.: PCT/US2021/053573

§ 371 Date: Apr. 5, 2023

Related U.S. Application Data
(60) Provisional application No. 63/087,464, filed on Oct. 5, 2020.

(51) Int. Cl. B01L 3/00

(52) U.S. Cl. CPC B01L 3/508; B01L 2200/145; B01L 2300/168; B01L 2300/1894; B01L 2300/043; B01L 2300/06

(57) ABSTRACT

A system for releasing analytes contained within a sample. The system comprises a housing enclosing an interior space. The system additionally comprises a sample holder having at least one receptacle configured to receive a sample containing analytes bound within the sample. The system further includes at least one light emitting diode configured to generate light sufficient to separate photo-cleavable bonds binding the analytes within the sample.

### CROSS-REFERENCE TO RELATED APPLICATION

The present application claims the priority benefit of U.S. Provisional Patent Application Ser. No. 63/087,464, filed Oct. 5, 2020, entitled LED ARRAY APPARATUS AND METHOD FOR ANALYTE CAPTURE AND RELEASE SYSTEMS, with the entirety of the above-identified provisional patent application being incorporated herein by reference.

### BACKGROUND OF THE INVENTION

### Field of the Invention

The present disclosure relates to an apparatus, system, and/or method for releasing exosomes (or other analytes) bound within samples, such as biological samples. More particularly, the present disclosure relates to an apparatus, system, and/or method for releasing exosomes (or other target analytes) magnetically bound to particles within samples while keeping the samples from overheating.

### Description of Related Art

Some existing technologies have been used to release analytes magnetically bound within samples. For example, certain prior art systems include the use of mercury bulb-based transilluminators to generate light at precise frequencies and power to release photo-cleavable bonds of exosomes magnetically bound within samples. However, use of such bulbs are known to produce excess heat, which is problematic for samples such as biological samples, which must be kept at relatively low temperatures. Additional issues with the existing technology include the size of the existing machines and inherent challenges with use of analog bulbs.

### SUMMARY OF THE INVENTION

To address the above-described challenges, the ability to generate light at necessary frequencies and power levels and apply such light to a sample so as to release exosomes (or other analytes) magnetically bound within the sample was investigated. However, the investigation required development of a system that would pose fewer issues with respect to the size of the system and the heat generated by the system. It was determined that a novel use of new ultraviolet (UV) light-emitting diodes (LEDs) can provide high power output in a solid state form factor, providing a narrow emission band, controllable power output, and a small form factor that could be placed into a refrigerator to run continuously and keep samples chilled while in operation.

For example, embodiments of the present disclosure include a system for releasing analytes contained within a sample. The system comprises a housing enclosing an interior space. The system additionally comprises a sample holder having at least one receptacle configured to receive a sample containing analytes bound within the sample. The system further includes at least one light emitting diode configured to generate light sufficient to separate photo-cleavable bonds binding the analytes within the sample.

Embodiments of the present disclosure also include a method for releasing analytes contained within a sample. The method comprises a step of providing a system that includes a housing, a sample holder configured to be positioned with the housing, and at least one light emitting diode. An additional step includes placing at least one sample within the sample holder, with the sample containing magnetically bound analytes. An additional step includes positioning the sample holder within the housing. An additional step includes activating the at least one light emitting diode, so as to emit light onto the sample. The light being emitted onto the sample is sufficient to release the magnetically bound analytes. A further step includes removing the sample from the system.

This summary is not intended to identify essential features of the present disclosure, and is not intended to be used to limit the scope of the claims. These and other aspects of the present disclosure are described below in greater detail.

### BRIEF DESCRIPTION OF THE DRAWINGS

Embodiments of the present disclosure are described in detail below with reference to the attached drawing figures, wherein:

FIG. 1 is a front perspective view of an exosome release system according to embodiments of the present disclosure;

FIG. 2 is a rear perspective view of the exosome release system from FIG. 1;

FIG. 3 is a front perspective view of the exosome release system from FIGS. 1 and 2, with a lid of the exosome release system in an open position;

FIG. 4 is a front elevation view of the exosome release system from FIGS. 1 and 2;

FIG. 5 is a cross-section of the exosome release system taken along the line 5-5 from FIG. 4;

FIG. 6 is a top exploded view of the exosome release system from FIGS. 1 and 2; and

FIG. 7 is a bottom exploded view of the exosome release system from FIGS. 1 and 2.

The figures are not intended to limit the present disclosure to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION

The following detailed description of embodiments of the disclosure references the accompanying figures. The embodiments are intended to describe aspects of the technology in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

The present disclosure is concerned with an apparatus, systems, and/or methods for releasing analytes bound in a sample. The analytes may comprise exosomes that are magnetically bound to other particles within a liquid sample. It will be appreciated that the target analyte will depend upon the details of capture assay used, and the design of the probe used to target and bind the target analyte. In more detail, affinity binding ligands specific for a particular target analyte can be attached to capture beads or particles to attract the exosomes or other target analytes within a sample to the beads or particles, such as in a microfluidics platform. An exemplary platform that may be suitable for used with the described apparatus, systems, and/or methods is described in PCT Publication WO 2020/086471, filed Oct. 21, 2019, and U.S. Pub. No. 2021/0268121, filed Apr. 21, 2021, each of which is incorporated by reference herein in its entirety. The affinity binding ligand is attached at one end to the particle or bead, and has at its other end a moiety or binding element with binding specificity to the target. The link of the ligand comprises a photocleavable linkage that can be broken upon exposure to the appropriate wavelength. Advantageously, the beads or particles are preferably metal (ferrous), so that the beads or particles can be magnetically immobilized in a desired location before, during, or after capture of the target analyte in the sample, such as by positioning an external magnet adjacent to the sample in a suitable container and magnetically attracting the beads or particles to congregate in that location. After magnetically immobilizing the beads or particles with the bound target analytes, the photo-cleavable bonds between the particle and the target analytes may need to be broken, such that the target analytes can be released from the particles and subsequently isolated from the sample.

Embodiments of the present disclosure provide a novel system, which generates ultraviolet (“UV”) light via light-emitting diodes (“LEDs”) to release the exosomes (or other target analytes) that may be present in the various samples by breaking the photo-cleavable linkage binding the exosomes to particles within the samples. As was described in the background section above, off-the-shelf options for obtaining necessary UV wavelength are not very prevalent. A tool called a transilluminator was tested, but was found to be a “non-ideal” solution for the releasing of the exosomes. The issues that became apparent with the transilluminator were that it produced excess heat, which forced the users to cycle the samples between the transilluminator and a refrigerator to keep the sample within the desired temperature range. The transilluminator was also physically too large to be kept in the refrigerator, and generally too inconvenient to be used for exosome release tools. As such, the need for a bespoke exosome- or analyte-release apparatus, system, and/or method became apparent.

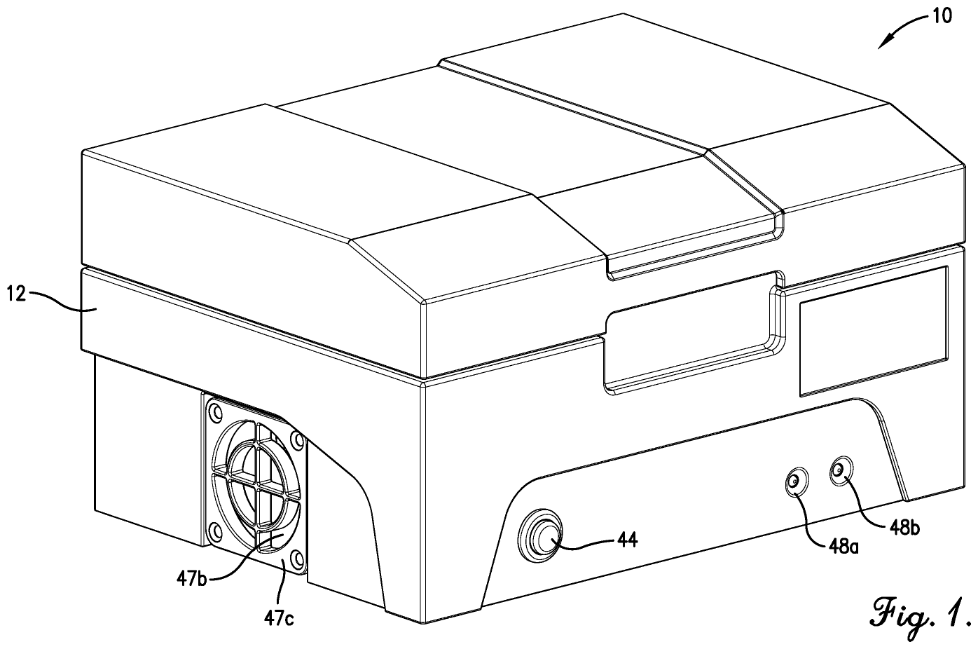

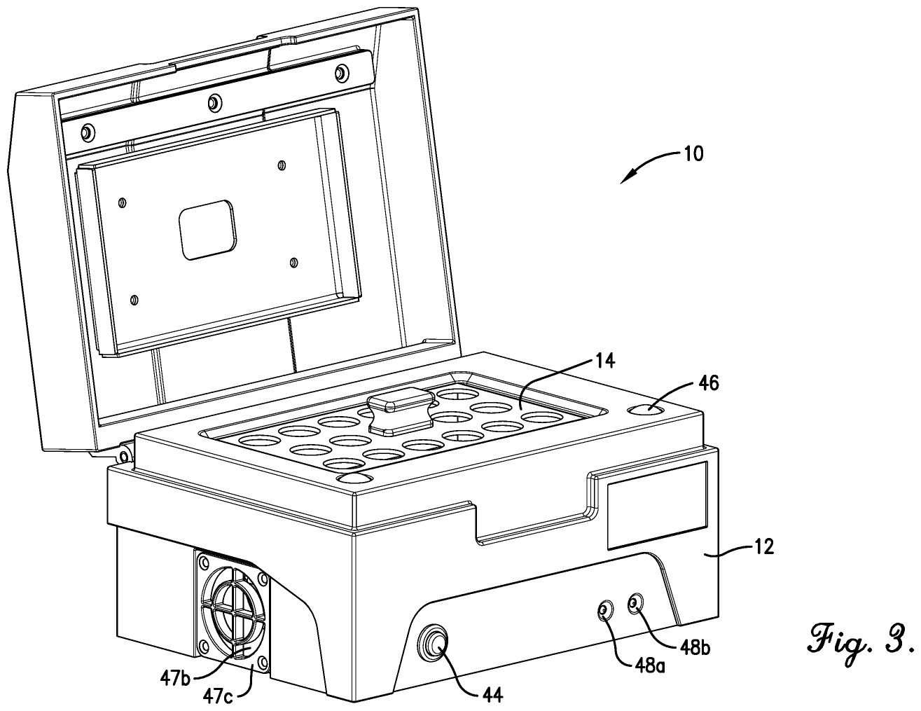

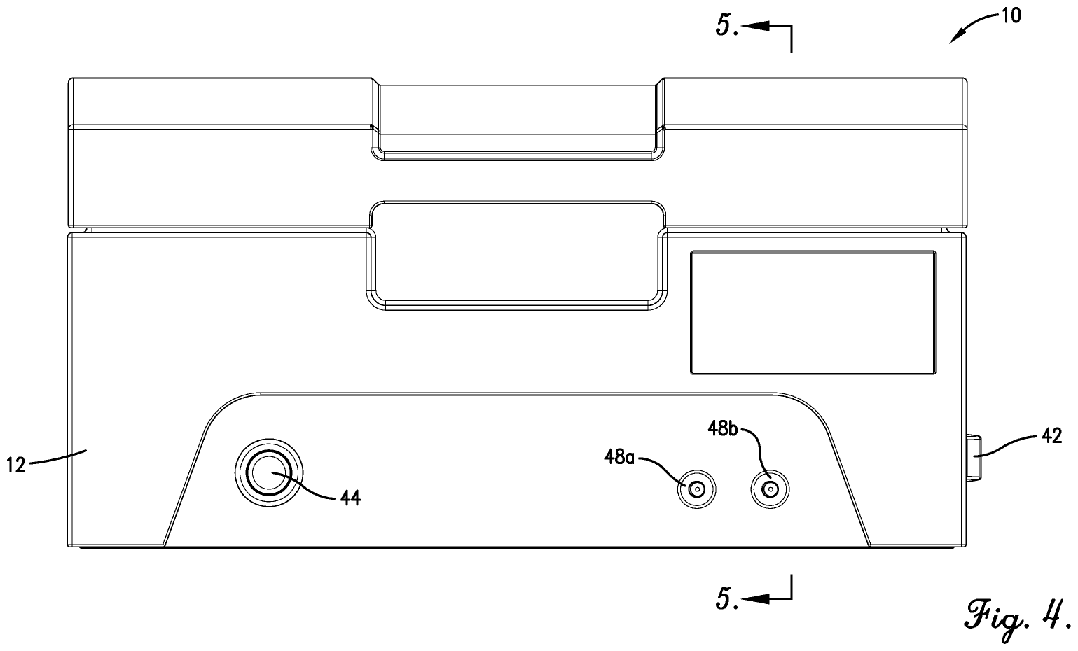

An exemplary analyte release system 10 is illustrated in FIGS. 1-7 for releasing exosomes (or other target analytes) bound to particles within a sample. The system 10 may broadly comprise a housing 12 that encloses an interior space and/or a UV chamber configured to hold one or more samples that may contain the target analyte (e.g., exosomes). As illustrated by FIGS. 3, 6, and 7, the samples may be contained within vials that can be supported within a sample holder 14 configured to be removably received within interior space and/or the UV chamber of the housing 12. As illustrated, the container or sample holder 14 may comprise any suitable receptacle for containing a liquid sample, such as a tray with a plurality of openings, cavities, or receptacles that can hold and support a plurality of vials of liquid sample. The sample container or holder 14 may likewise include a beaker, a flask, a cylinder, a tube, a titer plate, a micro-titer plate, an array assembly, a substrate, or a Petri dish, and the like. The sample container or holder 14 may be formed from a UV transparent (preferably substantially clear) material, such as glass, or various polymers and plastics configured to permit UV light/radiation to pass through or permeate the sample holder 14 so as to be incident upon the samples being supported by the sample holder 14.

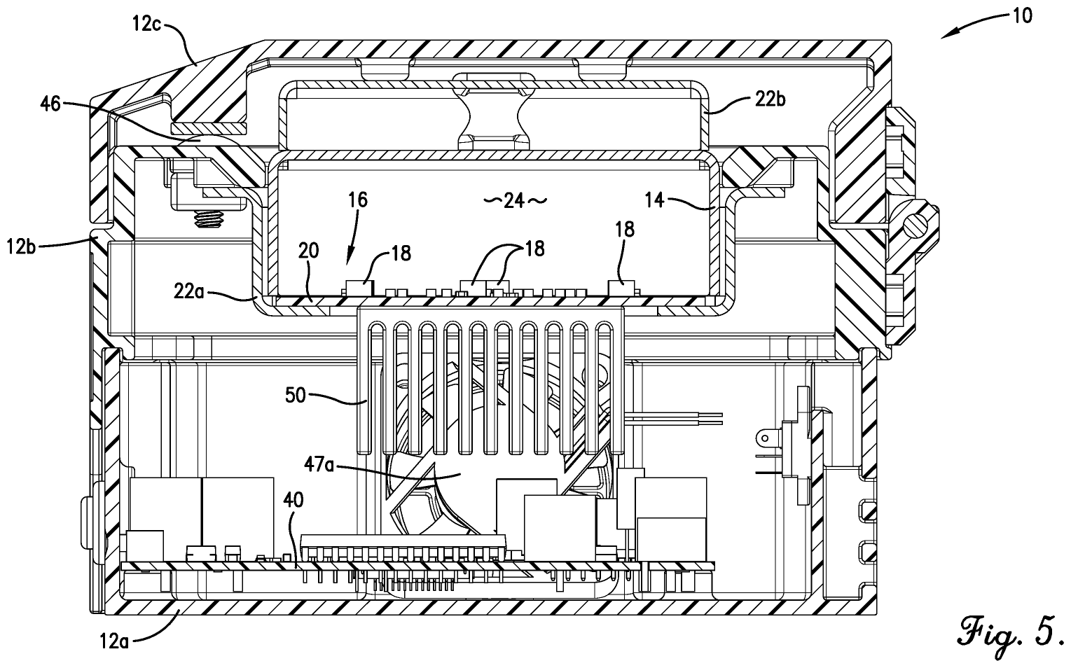

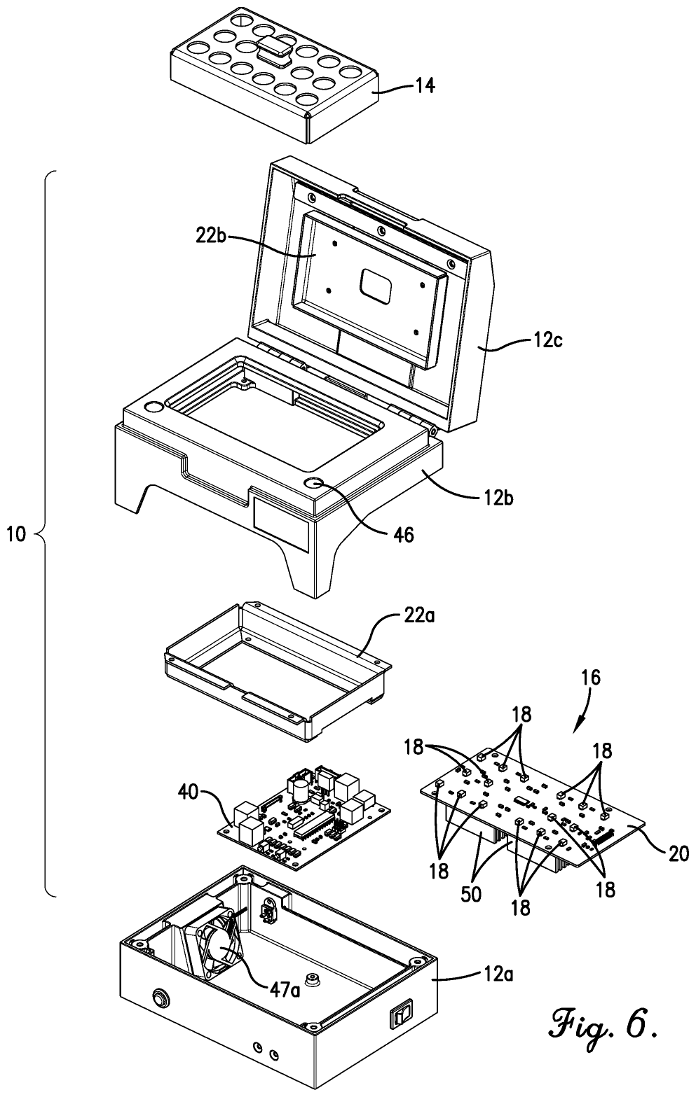

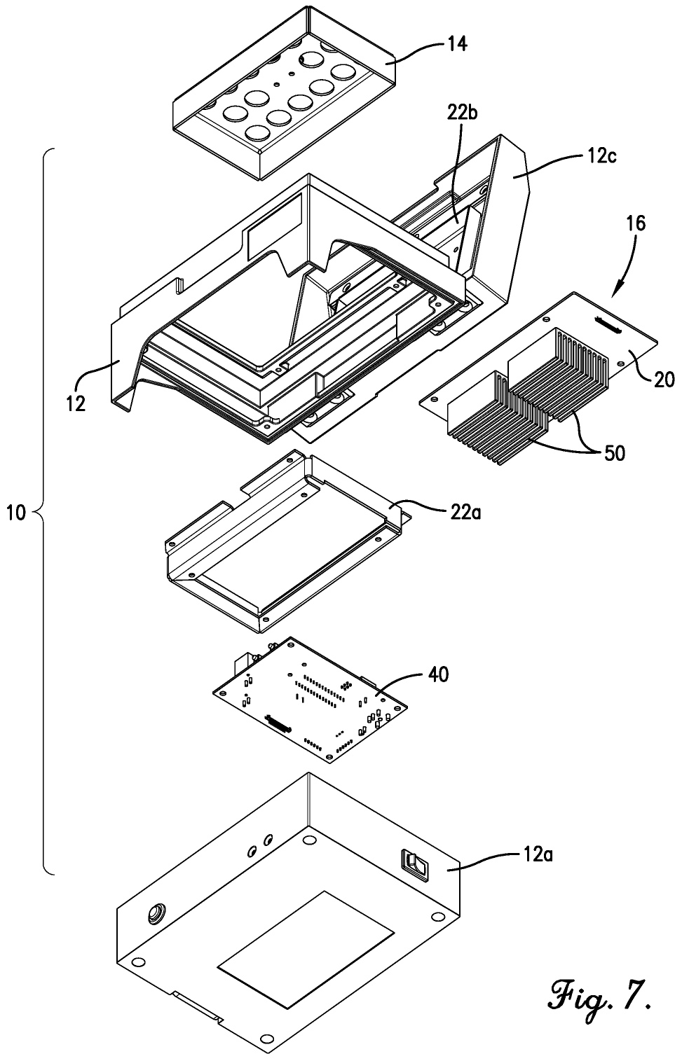

As perhaps best illustrated by FIGS. 6 and 7, the apparatus housing 12 may include a base 12a, a main section 12b, and a lid 12c, with the lid 12c being pivotably connected to the main section 12b (e.g., via one or more hinges). As such, the lid 12c can be shifted from an open position to a closed position, so as to open and/or close the housing 12 to provide selective access to the interior space and/or the UV chamber within the housing 12. In alternative embodiments, the lid 12c may be form fit to the main section 12b, such that the lid 12c can be lifted on/off the main section 12b. The base 12a, the main section 12b, and the lid 12c house the UV chamber, with the base 12a being coupled with the main section 12b which slips over-top of the base 12a (see, e.g., FIG. 5). Several fasteners (e.g., screws) may be used to secure the base 12a to the main section 12b, hidden from view when the system 10 is sitting flat on a table. The main section 12b has a cutout top portion that allows the sample holder 14 to be removed and replaced (e.g., dropped) within the interior space and/or UV chamber defined by the housing 12 when the lid 12c is in the open position. A top surface of the sample holder 14 may include a handle to facilitate ease of manipulation by a user of the system 10 (e.g., for removing and replacing the sample holder 14 within the housing 12). In alternative embodiments, the system 10 may include a sliding mechanism to facilitate the sample holder 14 being removed/replaced with respect to the housing 12. For example, the sample holder 14 may be configured to slide (via the sliding mechanism) out of/into openings formed in the side, back, or front of the housing 12 to facilitate loading/unloading of samples.

In some embodiments, the housing 12 may be formed from nylon by 3D printing (e.g., selective laser sintering “SLS”) for quick manufacturing and/or to incorporate on-the-fly edits. In embodiments in which the housing 12 is 3D printed the system 10 may include at least four 3D printed parts, including the base 12a, the main section 12b, the lid 12c, and the sample holder 14. In alternative embodiments, the housing 12 may be from a polymer, such that the housing 12 may be injection or cast molded. In further alternatives, the housing 12 may be formed from composite materials, from aluminum or steel sheets, or from milled aluminum or steel.

Remaining with FIGS. 6 and 7, the system 10 may additionally include a UV LED assembly 16 received within the housing 12 and configured to be positioned, for example, below the sample holder 14, such that UV light can be generated and incident upon the samples so as to cleave the exosomes' photo-cleavable linkage with the respective particles and release the exosomes contained within the samples. The UV LED assembly 16 may comprise an array of UV LEDs 18 supported on an LED circuit board 20. In other embodiments, the UV LEDs 18 may be supported by a well-plate, such as on the sample holder 14, or on a microfluidics channel, such as described in PCT Publication WO 2020/086471 and further below in this patent application. In some embodiments, the number of UV LEDs 18 included in the UV LED assembly 16 may correspond with and/or match the number of openings or receptacles included within the sample holder 14. As such, embodiments provide for at least one UV LED 18 for each well or vial of liquid samples that can be held by the sample holder 14. For example, as shown in the figures, the sample holder 14 may include sixteen openings, wells, or receptacles, such that the sample holder 14 can support sixteen liquid samples. In alternative embodiments, the sample holder 14 may include from one to two-hundred fifty-six openings or receptacles to hold from one to two-hundred fifty-six sample aliquots or different samples, from one to ninety-six openings or receptacles to hold from one to ninety-six samples, from ten to twenty-four openings or receptacles to hold from ten to twenty-four samples, or about sixteen openings or receptacles to hold about sixteen samples, or about twenty openings or receptacles to hold about twenty samples. In some embodiments, the UV LEDs 18 may each be positioned directly below one of the openings or receptacles of the sample holder 14 (i.e., centered below the receptacles), such that the UV LED's 18 are each be positioned directly below a sample aliquot, so as to be configure to directly incident UV light onto each sample.

In some embodiments, an interior surface of the housing 12 (or at least a portion thereof) may be formed from (or may be lined with) aluminum or another material configured to reflect UV light so as to keep the UV light retained within the housing 12 and accentuate UV light for incidence upon the samples held within the housing 12. For example, as illustrated in FIGS. 5-7, the system 10 may comprise a UV guard assembly that at least partially bounds and/or defines the UV chamber within the housing 12. The UV guard assembly may comprise a guard base 22a and a guard top 22b. As perhaps best shown in FIGS. 6 and 7, the guard base 22a may comprise a four-sided, generally rectangular frame (with an open top and an open bottom) that is secured to the main section 12b of the housing 12 (see, e.g., FIG. 5). As such, the guard base 22a extends down from the main section 12b of the housing 12 down into an interior space of the housing 12. The LED circuit board 20 may be secured to the bottom of the guard base 22a and/or supported by the bottom of the guard base 22a (e.g., positioned within the open bottom of the guard base 22a). One or more insulating bushings may be used to connect the LED circuit board 20 with the guard base 22a so as to electrically insulate the LED circuit board 20 from the guard base 22a. The guard top 22b may be secured to the interior side of the lid 12c of the housing 12. As such, when the lid 12c of the housing 12 is in the closed position, as shown in FIG. 5, the UV guard assembly (i.e., the guard base 22a and the guard top 22b) in conjunction with the LED circuit board 20 may at least partially enclose the UV chamber 24 of the system 10. As such, the sample holder 14 can be placed within the UV chamber 24 of the system 10 (see, e.g., FIG. 5), such that the samples being held by the sample holder 14 can be exposed to the UV light generated by the UV LED's 18. Notably, the UV guard assembly may be formed from aluminum or other material configured to reflect UV light, such that the UV light remains generally contained within the UV chamber 24 and accentuates the UV light for incidence upon the samples during operation of the system 10. The aluminum of the UV guard assembly may comprise 16 or 14 gauge aluminum sheets sufficient to contain and reflect UV light to maximize exposure of the samples to UV light and to minimize leakage of UV light outside of the UV chamber and/or outside of the housing 12. In some alternative embodiments, the UV guard assembly may be (i) milled out of an aluminum block, (ii) formed from aluminum sheets with polished finish or other chemical surface alterations, or (iii) formed from non-metallic materials that reflect UV light, such as ePTFE. In further alternatives, the guard base 22a may include a closed bottom surface, while the LED circuit board 20 is secured to a bottom side of the closed bottom surface. To facilitate emission of UV light into the UV chamber, the bottom side of the guard base 22a may include a plurality of through-holes that are aligned with the UV LED's 18, such that the UV LED's 18 may emit UV light through the guard base 22a and into the UV chamber for incidence upon the samples.

Certain embodiments of the present disclosure incorporate sixteen UV LEDs 18 positioned on the LED circuit board 20 and each pointing upward towards the samples being held by the sample holder 14. Other embodiments of the present disclosure may incorporate ten UV LEDs 18 arranged in a two by five matrix or pattern. Regardless, embodiments may provide for various other numbers of UV LEDs 18 to be used (e.g., from one to two-hundred fifty-six UV LEDs 18, from one to ninety-six UV LEDs 18, from ten to twenty-four UV LEDs 18, or about sixteen UV LEDs 18, or about twenty UV LEDs 18). As noted previously, in some embodiments, the number of UV LEDs 18 included in the system 10 may correspond to the number of samples intended to be processed by the system 10. For instance, in some embodiments, the system 10 will be configured to operate via a batch process on sixteen samples at a time, such that the system will include sixteen UV LEDs 18. In other embodiments, the system will be configured to operate via a batch process on generally any number of samples at a time, such that the system will include a corresponding number of UV LEDs 18 (i.e., the number of UV LEDs 18 is equal to the number of sample vials). In various other embodiments, the system 10 may include more or less UV LEDs 18 than samples.

Furthermore, the UV LEDs 18 may, in some embodiments, be configured to have their positions or aiming directions changed, such that the UV LEDs 18 can direct UV light onto the samples at generally any angle (e.g., to provide the samples with up to three-hundred sixty degree exposure). To further facilitate such exposure, the UV LEDs 18 may be positioned below, on the sides, and/or above the samples. In further embodiments, the UV LEDs 18 may be configured to emit either direct UV light or non-direct UV light (e.g., dispersed light) onto the samples.

The UV LEDs 18 of the system 10 may comprise low-wattage, UV-producing LEDs, encased in an aluminum shell, particularly configured to release exosomes (or other analytes) magnetically bound to particles within samples. In certain specific embodiments, the UV LEDs 18 are particularly configured to generate a narrow wavelength, of less than about 400 nm, less than about 375 nm, from about 360 nm to about 370, from about 365 nm to about 370, or about 368 nm, which is configured to processes the samples in a quick and efficient manner by cleaving the photocleavable linkage between the target analyte and the capture particle or bead. For example, the output of each of the UV LEDs 18 may be individually controlled (e.g., via the LED circuit board 20 and/or by a separate control system discussed in more detail below) to generate an UV light having a wavelength of 365 nm plus or minus 5 nm. The power output of each UV LED 18 may also be individually controlled. Regardless, in certain embodiments, the UV LEDs 18 may be configured to generate UV light or radiation with both UVA and UVB components. The UVA component may have a wavelength from 315 to 400 nm, while the UVB component may have a wavelength from 280 to 315 nm. In further embodiments, the system 10 may include LEDs (or other light sources) that are configured to generate light at extended ranges of wavelengths (e.g., from 10 to 1000 nm). The UV LED's 18 may be powered via pulse-width modulated signals generated by the LED circuit board 20 and/or by the separate control system discussed in more detail below.

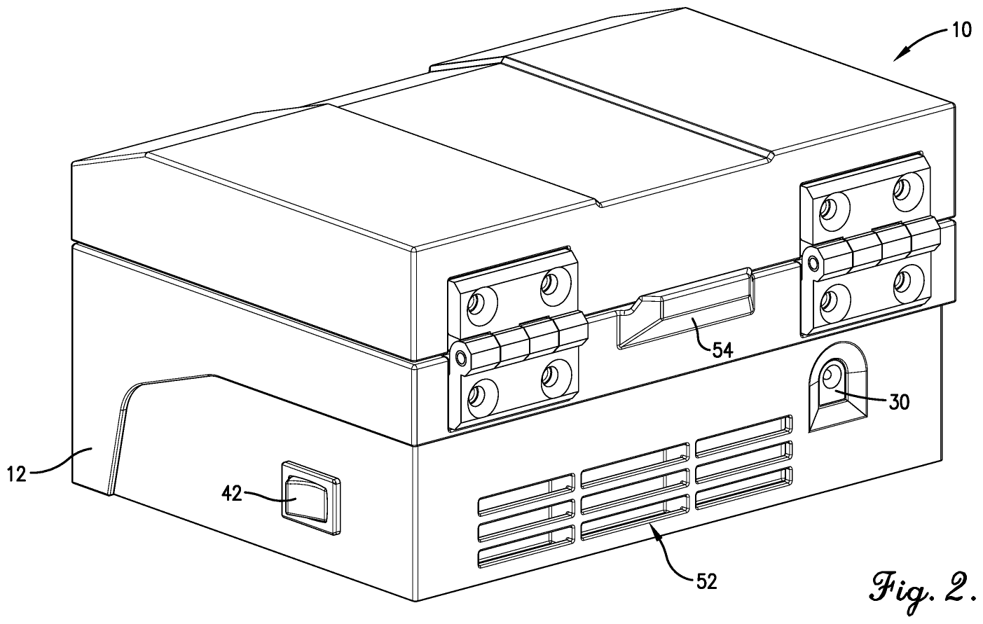

The system 10, including the UV LEDs 18, may be powered by a battery held within the housing 12. Alternatively, or in addition, the system 10 may be powered by an external power source (e.g., mains power) connected via a power adapter though an electrical connection/plug extending through the housing 12 (see, e.g., FIG. 2). In some specific embodiments, the system 10 may be powered using direct current at 24 Volt 36 Watt power.

The system 10 may include a control system 40 that controls one or more of the electronic components of the system 10. The control system 40 may comprise one or more processing elements and/or one or more memory elements, which are supported on a circuit board. The control system 40 may include one or more input/output ports for receiving information/data from components of the system 10 and/or for generating/sending control signals to components of the system 10. For example, the memory elements of the control system 10 may store a computer program that can be executed by the processing elements to carryout various of the functions described herein. Some of such functions include receiving information/data from components of the system 10, processing/analyzing such information/data, and generating/sending control signals to components of the system 10 based on such information/data. As illustrated in FIGS. 5-7, the control system 40 may be housed within the housing 12, such as secured to the base 12a of the housing 12.

Turning to the control system 40 in more detail, various components of the system 10 may provide inputs to the control system 40. For example, the battery or other electrical power source may be an input that provides power to the control system 40 (e.g., via the electrical connection/plug 30). In some embodiments, the system 10 may include a power switch 42 positioned on the exterior of the housing 12 (see, e.g., FIG. 2), which can be toggled to switch power to the system 10 on and off. The system 10 may also include a start button 44 or switch positioned on the exterior of the housing 12 (see, e.g., FIG. 1), which can be actuated to provide an input to the control system 10 to initiate a process of releasing analytes bound within samples held within the housing 12, as will be discussed in more detail below.

The system 10 may also include a lid safety switch 46 (see, e.g., FIG. 5) that can provide an input to the control system 40 in the form of an indication to the control system 40 as to when the lid 12c of the housing 12 is open or closed. In some instances, exposure to UV light can be dangerous to humans. As such, the control system 40 can deactivate the UV LEDs 18 when the lid safety switch 46 provides an indication that the lid 12c of the housing 12 is in the open position. In some embodiments, the lid safety switch 46 may be an electrical/magnetic contact switch that is positioned at a front of the housing 12 so as to provide an indication of when the lid 12c is open or closed. The lid safety switch 46 may alternatively comprise a push button switch, a Reed sensor with magnet, a Hall effect sensor, and/or an analog/digital proximity sensor. In alternative embodiments, the lid safety switch 46 may comprise a switch plate positioned at a back of the housing 12. In still further embodiments, the lid safety switch 46 may be incorporated with the hinges that connect the lid 12c to the main section 12b of the housing 12. In other embodiments, the lid safety switch 46 may also comprise a magnetic latch that functions to maintain the lid 12c in the closed position during operation of the system 10. However, in other embodiments, the system 10 may incorporate one or more additional magnetic latches that are separate from the lid safety switch 46. Such latches may be used to aid in keeping the lid 12c in the closed position.

The control system 40 may have a plurality of outputs that are used to control various components of the system 10. For example, as was noted previously, the control system 40 may be communicatively coupled with the UV LED assembly 16, so as to digitally control the UV LED assembly 16, including the UV LEDs 18 thereof. In addition to activating/deactivating the UV LED's 18 on and off, the control system 40 may control the intensity or brightness of the UV LED's (e.g., via a potentiometer associate with the control system 40). For example, the UV LEDs 18 may be configured to have their intensities varied from 0.1 to 1000 mW/cm 2.

The control system 40 may also be communicatively coupled with a cooling fan 47a integrated within a side of the housing 12 (see, e.g., FIGS. 5 and 6) that can be used to push or pull air through the interior space of the housing 12, so as to cool (i.e., reduce or maintain the temperature of) the electrical components of the system 10. The control system 40 may also be communicatively coupled with one or more indicators positioned on an exterior of the housing 12, which provide information to a user of the system 10. For instance, the indicators may comprise indicator lights, such as colored LEDs 48a, 48b that indicate whether the system 10 is powered on, whether the system 10 is running (e.g., performing a process of releasing analytes from samples held within the housing 12), whether the system 10 has been paused, whether the system 10 has completed a process of releasing analytes from samples held within the housing 12, etc. Alternatively, the indicator may comprise a digital display screen or the like, so as to provide more complete information to a user of the system 10.

Operation of the system 10 will now be described in more detail. Initially, one or more samples may be created. As was discussed earlier, analytes, such as exosomes, can be bound to particles within a liquid to form a sample. Such a sample may be held in a vial. In more detail, affinity binding ligands can be used to attract exosomes or other target analytes within a sample to metal beads or particles. Magnetic particles functionalized with photo-cleavable, affinity probes (active moieties) for capturing the exosomes are mixed with the sample suspected of containing the exosomes or other target analytes. The affinity probe can include an antigenic peptide, antibody, aptamer, nanobody and other affinity-based probes. The methods comprise mixing a biological sample containing exosomes (or another target) with the particles or beads and a wash buffer to form a mixture; allowing the exosomes to react and affinity bind with the particles; and collecting the exosomes bound to the immunomagnetic particles by applying a magnetic field within a collection chamber and releasing the bound exosomes.

A microfluidics platform may be used to bind the exosomes to the particles. An exemplary microfluidic platform may include a magnetic anisotropic oscillation unit in which both the analytes and magnetic particles can be introduced into a mixing channel. While in the mixing channel, the analytes and magnetic particles can be exposed to a magnetic field via two Helmholtz coils configured to induce orthogonal oscillating motion across the width of the channel (i.e., orthogonal to the flow direction of the analytes and particles through the channel), and can induce the magnetic probes (e.g., magnetic beads or particles) to dynamically move inside the channel along a direction of the magnetic field. As the direction of the magnetic field changes, the directional movement of magnetic particles within the microfluidics channel also changes. This can be used to foster interaction (and association/binding) between the magnetic particles and targets present in a sample fluid. The resulting fluid (i.e., with analytes magnetically bound to particles) can be extracted from the channel and provided into vials. After binding the target analytes to the particles, the photo-cleavable linkage needs to be broken, such that the analytes can be released and isolated from the sample.

The analyte release system 10 described herein may be used to release the exosomes (or other analytes) from the particles or beads. That is, upon exposure to the UV light, the linker between the captured target and the bead is cleaved, thereby releasing the targets, which flow downstream away from the magnetically-immobilized beads to the outlet of the microfluidic device. The released targets can then be collected for analysis and therapeutic use. It will be appreciated that the beads can then be subsequently collected for re-use by removing the magnetic field from the microfluidic device, such that the beads are no longer magnetically immobilized.

The system 10 may be used while supported on a shaker table and/or within a refrigerator unit used to maintain the samples at a specified temperature (preferably less than 10° C.). In more detail, electrical power may be supplied to the system 10, such as by connecting the system 10 to a facility's mains' power via a cable (or power adapter) coupled between the electrical connection/plug 30 on the housing 12 and a power outlet of the facility. Alternatively, a rechargeable, integral battery (internal or external) may be used to provide power the system 10. Regardless, the system 10 may be placed within a refrigerator unit, if necessary, to help maintain the system 10 and/or the samples held within the system 10 at requisite temperatures.

For example, in some embodiments, the system 10 may be configured (while positioned within the refrigerator) to keep samples held within the system 10 to a temperature of less than ° C., from 2° C. to 8° C., and/or about 5° C. As was described, the system 10 includes various electrical components, such as the UV LEDs 18 and control system 40, which output heat during operation. To aid in maintaining the request (relatively cool) temperature of the samples held within the system 10, the system 10 may include the fan 47a which is configured to push air through the internal space of the housing 12 so as to cool the electrical components of the system and/or to cool the samples. In certain embodiments, the fan 47a may be associated with a filter 47b (see, e.g., FIG. 1) that is rated at MERV 5.0 so as to be configured to filter dust, fibers, and other particles between 3.0-10.0 microns. The filter 47b may be held in place between the fan 47a and the exterior of the housing 12 via a filter guard 47c, as shown in FIG. 1. In some alternate embodiments, the system 10 may include multiple cooling fans for both pulling air into the housing 12 and for pushing air out of the housing 12. Further embodiments may include a Peltier module, refrigerant cooling system, or other liquid cooling system to aid in keeping samples cool. Other variations of a cooling system, such as a temperature control module configured to maintain the system 10 at a temperature between 0° C. and 40° C. may be used. In some additional embodiments, the system 10 may include one or more heat sinks 50 secured to a bottom side of the LED circuit board 20, as shown in FIGS. 5-7. The heat sinks 50 are configured to draw heat from the UV LEDs 18 and/or LED circuit board 20 for efficient dissipation. For instance, as shown in FIG. 5, the heat sinks 50 may extend down from the LED circuit board 20 into the interior space of the housing 12, such that cooling airflow generated by the fan 47a can assist in removing heat from the heat sinks 50 and/or from the system 10. For instance, the fan 47a may draw cool, refrigerated air from outside the housing 12, push such air through the internal space of the housing 12 (e.g., across the heat sinks 50), and out of the housing 12 via exhaust vents 52 formed on the back side of the housing 12 (see, e.g., FIG. 2). In view of the above, the system 10 may be specifically configured (e.g., when placed within a refrigerator and/or during use of the cooling fan 47a) to maintain the samples at the general temperature inside the refrigerator (generally between 2° C. and 8° C.) without raising the temperature of the samples (i.e., preventing the samples from increasing in temperature) and/or by not raising the temperature of the samples by more than about 0.1° C., 0.5° C., 1° C., 2° C., 3° C., or 5° C.

Once the system 10 is positioned within the refrigerator, the lid 12c of the housing 12 may be shifted from the closed position to the open position so as to provide access to the sample holder 14. As perhaps best shown on FIG. 2, the back side of the housing 12 may include a projection, in the form of a lid rest 54, which helps support the lid 12c in the open position and to prevent the lid 12c from over-extending in the open position. The sample holder 14 can be removed from the housing 12 and placed on a workspace where vials of sample liquid (e.g., which include exosomes magnetically bound to particles) can be placed within the receptacles of the sample holder 14. It should be understood, however, that samples may be inserted or remove from the sample holder 14 without removing the sample holder 14 from the housing 12. Regardless, as shown in the figures, the sample holder 14 may include sixteen receptacles, such that sixteen vials of sample can be placed within the sample holder 14. In some embodiments, each of the receptacles of the sample holder 14 should receive a vial, even if there are not enough samples to be processed (e.g., empty vials may be placed in one or more receptacles of the sample holder 14).

In further alternatives, an automatic fluid pump may be used to fill vials already positioned within the housing with sample liquid. Such that the samples can be processed, as described herein. In further alternatives, a conveyor system may be used to load single sample vials (or multiple vials simultaneously) one after another within the housing 12 for processing in sequence. A such, the system 10 may be configured for continuous processing and/or automated handling, as opposed to batch processing.

Upon the sample holder 14 being filled with vials of sample, the sample holder 14 can be replaced back into the housing 12. Specifically, with the lid 12c in the open position, access is provided to the interior space and/or the UV chamber 24 of the housing 12. As was described previously, the system 10 may include a UV chamber 24 within which UV light generated by the UV LEDs 18 is emitted and generally contained. The UV chamber 24 may be defined as the portion of the interior space of the housing 14 that is bound, at least partly, by the LED circuit board 20, the guard base 22a, and the guard top 22b (with the lid 12c in the closed position, as illustrated by FIG. 5). Thus, the sample holder 14 (including the vials of sample being held by the sample holder 14) can be dropped down into the interior space and/or the UV chamber 24 of the housing 12. In some embodiments, the sample holder 14 may include tabs (or other alignment components) that fit in association within gaps formed of the housing 12 and/or in the guard base 22a to ensure proper positioning/alignment of the sample holder 14. Such proper alignment may ensure that each of the UV LED's 18 is properly aligned with a vial sample, as was previously discussed.

Thereafter, the lid 12c of the housing may be shifted to the closed position. As was described earlier, due to the presence of the lid safety switch 46, the UV LED's 18 may not be activated until the lid 12c is closed (thereby enclosing the UV chamber 24 within the volume defined by the LED circuit board 20, the guard base 22a, and the guard top 22b). Such a feature ensures that the user of the system 10 will not become unwantedly exposed to UV light. Next, the start button 44 may be pressed to initiate the process of photo-cleaving the photo-cleavable linkage between the exosomes and the particles (i.e., the exosome release process). Such an exosome release process includes the activation of the UV LED's 18, which generate the UV light at the requisite frequency and/or power and direct such UV light at the samples. The exosome release process (including emitting UV light at the samples) may be performed for a pre-defined time period, which may be between one and sixty minutes, about ten minutes, about fifteen minutes, about twenty minutes, or some other time period. In one or more embodiments, the light release step is carried out with exposure times of 15 minutes or less, preferably about 13 minutes or less, more preferably about 12 minutes or less, and even more preferably approximately 100% of the captured target analyte is preferably released/cleaved within about 10 minutes of exposure time.

Such a time period may be programmed into the control system 40, such that the control system 40 automatically activates the UV LED's 18 upon the selection of the start button 44 and deactivates the UV LED's 18 at the expiration of the pre-defined time period. While the exosome release process is being performed by the system 10 (i.e., while the UV LED's 18 are activated) a first of the indicator lights 48a may be activated so as to indicate to the user that the exosome release process is underway. At the end of the exosome release process, a second of the indicator lights 48b may be activated so to indicate to the under that the exosome release process has ended. One or more of the indicator lights 48a, 48b may also be activated to indicate that the exosome release process has been paused or interrupted.

At the end of the process, the power switch 42 may be toggled to the off position, so as to disconnect the control system 40 from electrical power. The user may put on insulated gloves, open the lid 12c and remove the sample holder 14 that contains the sample vials with exosomes having been released from the particles. The sample vails may be removed from the sample holder 14, and the sample holder 14 may be replaced within the housing 12. The lid 12c may be closed, and the system 10 may be put away for storage. It should be understood that the exosome release process performed by the system 10 may be performed automatically (or partially automatically) by the system 10 after being initiated by the user (e.g., after pushing the start button 44). Specifically, the control system 40 may control the UV LED assembly 16 and the fan 47a, such that the system 10 can process the samples as required to release the exosomes from their respective particles within the liquid samples using a light-release step without unwantedly raising the temperature of the samples. Although illustrated with a sample holder 14 configured to hold multiple vials of sample, the system can be used with other receptacles, including microfluidic/lateral flow devices, multi-well plates, and the like.

The system 10 may include one or more features in addition to those described above. For instance, in place (or in addition to) the manual power switch 42 and/or start button 44, the system 10 may be configured for wireless communication with a remote device (e.g., a user's laptop, tablet, smartphone, etc.). As such, the user can remotely provide power to the system 10 and/or start the exosome release process without having to physically manipulate buttons or switches associated with the housing 12 of the system 10.

Alternatively, or in addition, the system 10 may include an indicator in the form of a digital display screen that presents various information to the user, such as system 10 settings and/or operating parameters. For example, the display screen may display the current status of the exosome release process (e.g., ready for processing, currently processing, processing paused, finished processing, etc.). The display screen may also display the pre-defined time period for processing and/or processing speed that is currently set. The display screen may also be used to provide an alert to the user when the system 10 malfunctions or is need of maintenance. For example, the display screen may provide an indication when one or more of the UV LED's 18 have malfunctioned. In embodiments that include the digital display screen, the screen may provide a specific indication as to which one or more UV LED 18 has malfunctioned. Such information would be helpful to facilitate repair of the system 10. Other alerts that may be provided via the indicators and/or display screen, such as whether components of the system 10 are overheating and/or experiencing voltage-related issues.

In embodiments that include a display screen, such a screen may also be a user-interface in the form of a touchscreen, such that the user can program and/or operate the system 10 by providing instructions via the touchscreen. For example, as user may set the pre-defined time period and/or processing speed of the system 10 via the touchscreen. The user may define which, or how many, UV LEDs 18 should be used for a given exosome release process. The user may also define the intensity at which the UV LEDs 18 should operate during a given exosome release process. In various other embodiments, the user may vary operation of the UV LEDs 18 by defining dynamic cycles of intensity, dynamic wavelengths, and intermittent UV light exposure for the UV LEDs 18 during a given exosome release process (with such operating parameters based on requirements of a given sample/reagent type). In some embodiments, the system 10 may include one or more sample sensors that measures how well the exosomes in the sample are being released, and if necessary, automatically adjusting the operating parameters of the system 10 to facilitate more efficient operation. For example, the samples may be associated with fluorescent markers that change color depending on how well the exosomes are being released. Such fluorescent markers may be monitored manually by the user of the system 10 or automatically by one or more sensors associated with the system 10 (e.g., by video cameras, light sensors, etc.).

They system 10 may also include a wireless or wired link to a user's computing device (e.g., laptop, tablet, smartphone, etc.), such that the user can use the user's computing device as a user interface for the system 10 to control all operations of the system 10 (with such control options discussed above). The user's computing device may also be used to observe real-time operation of the system 10. For example, the system 10 may send operating parameters to the user's computing device. Furthermore, the system 10 may include one or more video cameras, which send live video feed to the user's computing device for livestreaming. The user's external computing device may also receive data from the system 10 (related to the system 10 and/or to the samples) for storage and further analysis. For example, embodiments may provide for data to be collected from the system 10 and transmitted to the external computing device. Such data may include operating parameters of the system 10, for example, (i) UV LED 18 performance, e.g., operating wavelengths and intensity of each UV LED 18, (ii) the pre-defined time periods being used for processing each of the samples, (iii) temperature of the system 10, e.g., within the interior space of the housing 12 and/or of the samples (individually or collectively), and/or (iv) generally any other data generated or obtained by the system 10 during operation.

As was noted above, the system 10 may be used in conjunction with a shaker table (inside or outside of a refrigerator) that facilitates the release of the exosomes. In some embodiment, the system 10 (and particularly the housing 12) may be sized to fit on an eight-inch by eight-inch shaker table. The system 10 may weigh less than about ten pounds so as to facilitate such operability with the shaker table. During use of the system with the shaker table, the magnetic latch (which may be part of the lid safety switch 46) can be used to keep the lid 12c closed during movement of the system on the shaker table. Alternatives to this latch include but are not limited to, physical snap latches, hook latches, clasp style latches, spring-loaded hinges, and/or a heavy lid 12c.

In addition to the shaker table, the system 10 may integrate a stirring mechanism to assist in mixing the samples during the exosome release process. Such a stirring mechanism may comprise a linear oscillator, an off-center electric motor, an impeller, dynamic magnetic field generator. Alternatively, or in addition, a vibrating mechanism may be used to agitate samples while being processed, such as a vibration motor, sonication, or ultrasonication. In still further embodiments, the samples may be passed through a microfluidic system to mix the samples. Chromatography, fluid filtration, may also be used to mix the samples by moving fluid through bound particles magnetically or otherwise. During or after exosome release processing, the system 10 may include magnetic separation racks to attract immune-capture particles/beads, while extracting unwanted fluid. The use of a Helmholtz coil (or other electromagnetic device) may be used to attract the immune-capture particles/beads.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

Further, the description of the embodiments disclosed herein may refer to various relative orientations, such as lower, upper, horizontal, vertical, above, below, up, down, bottom, top, and the like. These terms are used for convenience of description and are not intended to limit the scope of the invention in any way. Unless stated otherwise, these relative terms do not require the equipment to be constructed or operated in a particular orientation. Likewise, terms such as attached, connected, coupled, interconnected, and the like are used to mean structures that may be directly or indirectly attached to each other including in a movable or rigid attachment or relationship.

All terms used herein are to be broadly interpreted unless otherwise stated. For example, the terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are illustrative only, and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above described memory types are examples only, and are thus not limiting as to the types of memory usable for storage of a computer program.

The term “memory,” “memory area,” “memory element,” “storage device,” and the like, as used herein, may, unless otherwise stated, broadly refer to substantially any suitable technology for storing information, and may include one or more forms of volatile and/or non-volatile, fixed and/or removable memory, non-transitory computer readable media, such as read-only memory (ROM), electronic programmable read-only memory (EPROM), random access memory (RAM), erasable electronic programmable read-only memory (EEPROM), and/or other hard drives, flash memory, MicroSD cards, and others.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein. Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for releasing analytes contained within a sample, said system comprising:
a housing enclosing an interior space;
a sample holder having at least one receptacle configured to receive a sample containing analytes bound within the sample; and
at least one light emitting diode configured to generate light sufficient to separate photo-cleavable bonds binding the analytes within the sample.

2. The system of claim 1, wherein said housing comprises:
a main section, and
a lid pivotably coupled with said main section, such that said lid can shift between a closed position and an open position.

3. The system of claim 2, wherein when said lid is in the open position, said sample holder can be removed from or placed within said housing.

4. The system of claim 3, wherein when said sample holder is received within said housing, said sample holder is at least partially positioned within an ultraviolet (UV) chamber.

5. The system of claim 4, wherein said UV chamber is bound by a material configured to reflect UV light.

6. The system of claim 5, wherein the material comprises aluminum.

7. The system of claim 1, wherein said at least one light emitting diode is configured to emit ultraviolet (UV) light.

8. The system of claim 7, wherein said at least one light emitting diode comprises a plurality of light emitting diodes, each configured to emit ultraviolet (UV) light.

9. The system of claim 7, wherein the UV light has a wavelength between 280 and 400 nm.

10. The system of claim 2, further comprising a safety switch configured to sense whether said lid is in the open position or the closed position.

11. The system of claim 10, wherein said system is configured to prevent the at least one light emitting diode from emitting light when the safety switch senses that said lid is in the open position.

12. The system of claim 1, wherein said system is configured to prevent the sample from increasing in temperature.

13. The system of claim 12, further comprising a cooling fan.

14. The system of claim 12, wherein said system is configured to be placed within a refrigerator unit.

15. A method for releasing analytes contained within a sample, said method comprising the steps of:
(a) providing a system that includes—
a housing,
a sample holder configured to be positioned with the housing, and
at least one light emitting diode;
(b) placing at least one sample within the sample holder, wherein the sample contains a magnetic particle and at least one target analyte bound to said particle;
(c) positioning the sample holder within the housing;
(d) activating the at least one light emitting diode, so as to emit light onto the sample, wherein the light being emitted onto the sample is sufficient to release the at least one target analyte from said particle; and
(e) removing the sample from the system.

16. The method of claim 15, wherein the least one light emitting diode is configured to emit ultraviolet (UV) light.

17. The method of claim 15, wherein the housing comprises a main section and a lid pivotably coupled with the main section, wherein prior to said positioning of step (c), the lid is shifted from a closed position to an open position such that the sample holder can be positioned within an ultraviolet (UV) chamber within the housing.

18. The method of claim 17, wherein the UV chamber is bound by a material configured to reflect UV light, wherein the material comprises aluminum.

19. The method of claim 18, wherein the system further comprises a safety switch configured to sense whether the lid is in the open position or the closed position, wherein the at least one light emitting diode is prevented from emitting light when the safety switch senses that the lid is in the open position.

20. The method of claim 15, wherein during said activating of step (c), the sample is prevented from increasing in temperature.

21. The method of claim 15, further comprising the step of collecting data from the system and transmitting the data to an external computing device.
